(19) United States
(12) Patent Application Publication
(10) Pub. No.: US 2012/0005343 A1
(43) Pub. Date: Jan. 5, 2012

(54) COMMUNICATION ACCESS CONTROL SYSTEM OF VEHICLE

(75) Inventors: Sang Woo Ji, Hwaseong (KR); Hyun Cheol Bae, Suwon (KR); Hun Joung Yoon, Hwaseong (KR)

(73) Assignee: HYUNDAI MOTOR COMPANY, Seoul (KR)

(21) Appl. No.: 12/953,751

(22) Filed: Nov. 24, 2010

(30) Foreign Application Priority Data
Jun. 30, 2010 (KR) 10-2010-0062627

(51) Int. Cl. G06F 15/173

(52) U.S. Cl. 709/225

(57) ABSTRACT

A communication access control system of a vehicle that selectively operates one accessible module with a higher access priority in a current location of a first wireless communication module or a second wireless communication module receiving contents from a contents server in a wireless manner is provided. The communication access control system of a vehicle includes: a first wireless communication module and a second wireless communication module accessing a contents server to receive contents from the contents server in a wireless manner; and an access controller selectively operating one accessible module of the first wireless communication module or the second wireless communication module with a higher access priority in a current location of the vehicle.

### CROSS-REFERENCES TO RELATED APPLICATIONS

This application claims under 35 U.S.C. §119(a) the benefit of Korean patent application number 10-2010-0062627, filed on Jun. 30, 2010, which is incorporated by reference in its entirety.

### BACKGROUND OF THE INVENTION

1. Field of the Invention

The present invention relates to a system controlling a communication module of a vehicle to access a network.

2. Description of the Related Art

Digital Living Network Alliance (DLNA) is a public alliance guiding a common use of a world home network. The DLNA introduces a guideline based on electronic appliances, PC, IP, HTTP, UPnP, Wi-Fi widely used in wireless device manufacturing companies. Products designed according to the DLNA guideline allow users to freely share media contents such as music, photographs, and videos through a home network. The DLNA guideline can be defined with four function blocks, which includes a Digital Media Server (DMS), a Digital Media Controller (DMC), a Digital Media Renderer (DMR), and Digital Media Player (DMP).

The DMS serves to download contents from a contents server and to store and provide the downloaded contents. The DMC serves to control transmission of contents from the DMS. The DMR serves to transmit the contents to a peripheral DMR under the control of the DMC. The DMR serves to search, execute, and control contents received from the DMR.

Here, the DMS accesses the contents server using a wireless communication module. There is a WCDMA communication module, a WIBRO communication module, or a WI-FI communication module as an example of the wireless communication module. When the DMS uses only one of the wireless communication modules, for example, a WCDMA communication module, communication access coverage is 30 km per base station. This is an easy access in any location but a communication fee is expensive. Meanwhile, when the DMS uses another one of the wireless communication modules, for example, a WI-FI communication module, a communication fee is cheap but communication access coverage is small, which is 0.3 km per base station.

Accordingly, there is a need to provide a plurality of wireless communication modules accessing the DMS and the contents server and selectively operating the wireless communication modules according to a priority such as a location and speed of a vehicle, or a communication fee.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in view of the above problems, and provides a communication access control system of a vehicle that selectively operates one accessible module with a higher access priority in a current location of a first wireless communication module or a second wireless communication module receiving contents from a contents server in a wireless manner.

The present invention further provides a communication access control system of a vehicle that selectively operates another wireless communication module with a higher access priority when the another wireless communication module is in an accessible state at the time of movement of the vehicle although a specific wireless communication module is moving.

The present invention further provides a communication access control system of a vehicle capable of receiving setting of the access priority.

The present invention further provides a communication access control system of a vehicle that operates a first wireless communication module or a second wireless communication module only when the vehicle travels higher than a set speed.

In accordance with an aspect of the present invention, a communication access control system of a vehicle includes: a first wireless communication module and a second wireless communication module accessing a contents server to receive contents from the contents server in a wireless manner; and an access controller selectively operating one accessible module of the first wireless communication module or the second wireless communication module with a higher access priority in a current location of the vehicle.

A communication access control system of a vehicle of the present invention selectively operates one accessible module with a higher access priority in a current location of a first wireless communication module or a second wireless communication module receiving contents from a contents server in a wireless manner. Accordingly, the present invention can receive contents from a contents server using a wireless communication module that is preferentially accessed and in which a fee can be saved.

The communication access control system of a vehicle of the present invention checks accessibility and an access priority based on a moved location of the vehicle to selectively operate an accessible wireless communication module with a higher access priority. Accordingly, instead of a wireless communication module that is preferentially accessed and in which a fee can be saved, although a wireless communication module to be secondly preferential accessed operates, when the vehicle enters in a zone that the preferentially accessed wireless communication module is accessible, the present invention operates the preferentially accessed wireless communication module to save a communication fee to the utmost.

In addition, the communication access control system of a vehicle of the present invention operates a first wireless communication module or a second wireless communication module only when an operation limit speed of the first wireless communication module or the second wireless communication set by a setting device exceeds a current travel speed. Accordingly, the present invention may select an optimal wireless communication module in consideration of travel speed of the vehicle.

### BRIEF DESCRIPTION OF THE DRAWINGS

The objects, features and advantages of the present invention will be more apparent from the following detailed description in conjunction with the accompanying drawings, in which:

FIG. 1 is a block diagram illustrating the configuration of a communication access control system of a vehicle according to an exemplary embodiment of the present invention;

FIG. 2 is a flowchart illustrating an operation of a communication access control system of a vehicle according to an exemplary embodiment of the present invention; and

FIG. 3 is a view illustrating coverage of a wireless communication module by locations of a vehicle according to an exemplary embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

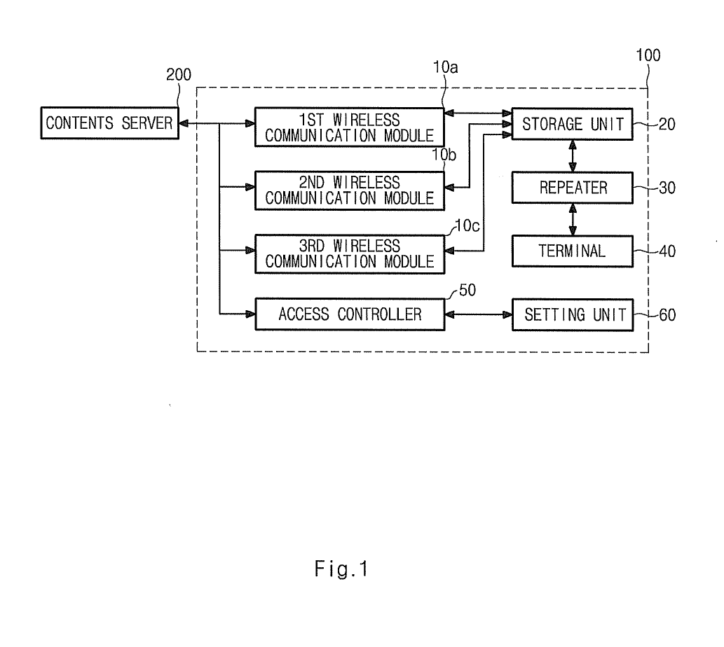

FIG. 1 is a block diagram illustrating the configuration of a communication access control system of a vehicle according to an exemplary embodiment of the present invention.

Referring to FIG. 1, a communication access control system 100 of a vehicle according to an exemplary embodiment of the present invention includes a first wireless communication module 10a, a second wireless communication module 10b, a storage unit 20, a repeater 30, a terminal 40, an access controller 50, and a setting unit 60.

The first wireless communication module 10a and the second wireless communication module 10b receive contents from a contents server 200 in a wireless way, and transfer the received contents to the storage unit 20. The storage unit 20 receives and stores the contents from the first wireless communication module 10a or the second wireless communication module 10b. The repeater 30 transfers the contents stored in the storage unit 20 to a peripheral terminal through Digital Living Network Alliance (DLNA). The peripheral terminal 40 executes the contents received through the repeater 30. Meanwhile, the access controller 50 selectively operates one of the first wireless communication module 10a and the second wireless communication module 10b which can access in a current position of a vehicle and the highest access priority. The setting unit 60 receives setting of an access priority with respect to the first wireless communication module 10a and the second wireless communication module 10b from a user.

Hereinafter, the communication access control system 100 of a vehicle according to an embodiment of the present invention will be described in detail by structural elements.

Construction of Wireless Communication Module

The first wireless communication module 10a and the second wireless communication module 10b receive contents from a contents server 200 in a wireless way. The first wireless communication module 10a is configured by a Wireless Fidelity (WI-FI) communication module. The second wireless communication module 10b is configured by a Wideband Code Division Multiple Access (WCDMA) communication module or a Wireless Broadband (WIBRO) communication module. Here, at least one of the first wireless communication module 10a and the second wireless communication module 10b may be provided.

The WCDMA communication module is one of the USA standard techniques used in a digital portable terminal using a spread spectrum technology. The WCDMA communication module has coverage of 30 km per base station, and can perform continuous data communication during high-speed travel. The WIBRO communication module refers to wireless broadband Internet. The WIBRO communication module has coverage of 10 km per base station. The WIBRO communication module can perform continuous data communication in a stop state, a walking state, or in a moving state at speed of 60 km/h. The WI-FI communication module is a local area network (LAN) that may use very high speed Internet within a predetermined distance in which a wireless access point (AP) is installed. The WI-FI communication module has coverage of maximum 500 m per base station and has a difficulty in being used at a high-speed travel. An access priority is determined in the first wireless communication module 10a and the second wireless communication module 10b by the setting unit 40 to be described below or a manufacturing company. An access priority can be determined in an order from the least communication fee to the greatest communication fee. For example, when a communication fee due to an operation of the WI-FI communication module is less than that of the WCDMA communication module or the WIBRO communication module, the WI-FI communication module can be set to a first priority.

Construction of Storage Unit

The storage unit 20 serves as a Digital Media Server (DMS) function block. The storage unit 20 receives contents from the first wireless communication module 10a or the second wireless communication module 10b, and stores the received contents in a separate contents database (not shown). The storage unit 20 manages the contents stored in the contents database using a separate broadcast middleware. The storage unit 20 includes, e.g., a VCR, a CD player, a DVD player, an MP3 player, a set-top box, a TV tuner, a radio tuner, and PC.

Construction of Repeater

The repeater 30 serves as a Digital Media Controller (DMC) and Digital Media Renderer (DMR) function block. The repeater 30 transmits contents stored in the contents server 200 to a terminal using a DLNA network. Here, the DLNA network advances standardization with respect to media network transmission, streaming protocol, and Digital Right Management (DRM) based on a Universal Plug and Play (UPnP) technique. The DLNA network will be described in detail. A network connection in the DLNA is achieved based on an Internet Protocol (IP). Due to this, devices connected to all DLNA networks can communicate with another device connected to Internet in all the worlds. Wired high-speed Ethernet 802.11u and wireless Ethernet 802.11a/b/g are used as a physical layer of the DLNA network, and the wireless Ethernet uses Wi-Fi according to increased wireless home network communication. A technology finding and controlling a device in the DLNA network uses conventional UPnP AV architecture and UpnP device architecture as a technique that automatically configures networking setting like IP address and manages recognition of another device on a network.

Construction of Terminal

The terminal 40 serves as a Digital Media Player (DMP) function block. The terminal 40 selects, controls, and executes the contents from the repeater 30 using the DLNA network. Here, since a wireless AP performing the same function as that of the repeater 40 is mounted in the terminal 40, the terminal 40 can execute the same function as that of the repeater 30. Namely, the present invention can perform transmitting and receiving contents between the repeater 30 [symbol] the terminal 40 [symbol] the terminal 40.

Construction of Access Controller and Setting Unit

The setting unit 60 receives setting of an access priority with respect to the first wireless communication module 10a and the second wireless communication module 10b from a user through a separate key input unit (not shown). Further, the setting unit 60 sets operational maximum speed ranges, namely, respective operation limit speeds of the first wireless communication module 10a and the second wireless communication module 10b by a manufacturing company. For example, the operation limit speed of the first wireless communication module 10a is set to 30 km/h and the operation limit speed of the second wireless communication module 10b is set to 60 km/h.

When a vehicle engine starts, the access controller 50 operates one with the higher access priority of the first wireless communication module 10a and the second wireless communication module 10b to access the contents server 200, but stops an operation of a remaining wireless communication module. Moreover, the access controller 50 checks whether another stopped wireless communication module with a high access priority can access the contents server 200 instead of a currently operated wireless communication module. When the another stopped wireless communication module can access the contents server 200, the access controller 50 stops the currently operated wireless communication module but operates the another stopped wireless communication module to access the contents server 200. Accordingly, the access controller 50 can operate a wireless communication module with a higher access priority that can operate in a current state.

Here, if the access controller 50 is receiving contents from the contents server 200, after receiving the contents completely, it should stop an operation of a wireless communication module with a lower access priority. In another embodiment, when the access controller 50 is receiving the contents from the contents server 200 upon stopping the operation of the wireless communication module with a lower access priority, it transfers receiving information, namely, contents identification, attribute information such as downloaded capacity/information or remaining capacity of the contents, to the contents server 200. Accordingly, the remaining capacity of the contents can be transferred instead through a wireless communication module with a higher access priority. Meanwhile, the access controller 50 checks a current travel speed of a vehicle using a separate travel speed determinator (not shown). Only when a wireless communication module with a higher access priority travels less than an operation limit speed set by the setting unit 60, the access controller 50 operates the wireless communication module.

The operation of the communication access control system 100 of a vehicle according to the present invention is described.

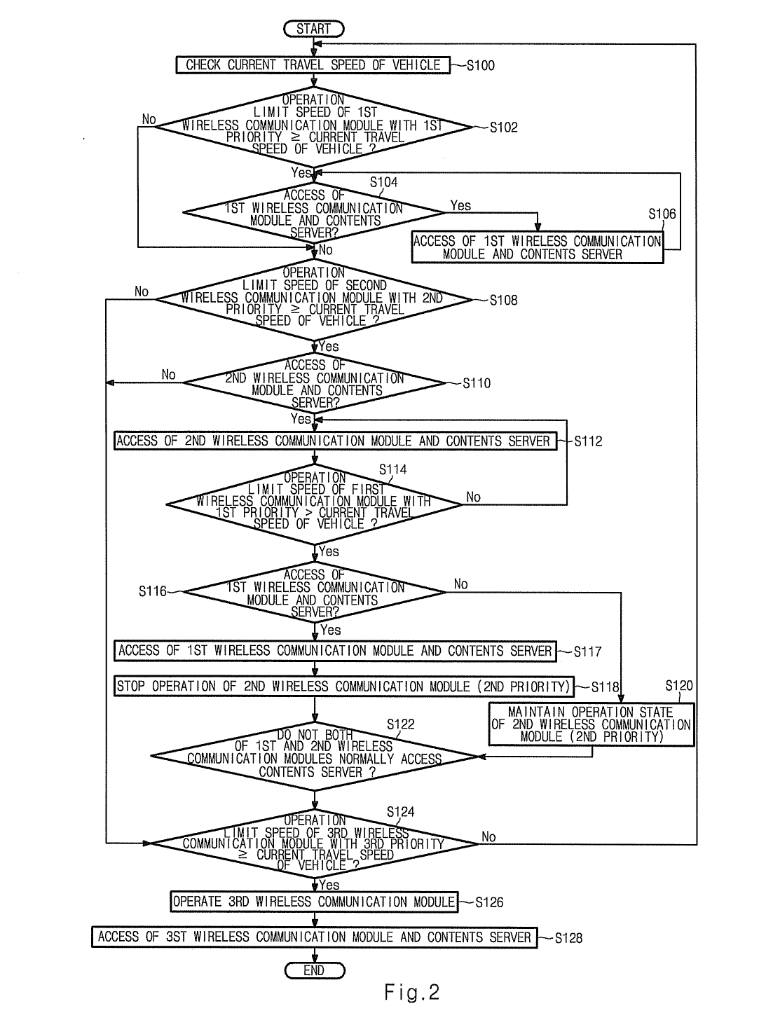

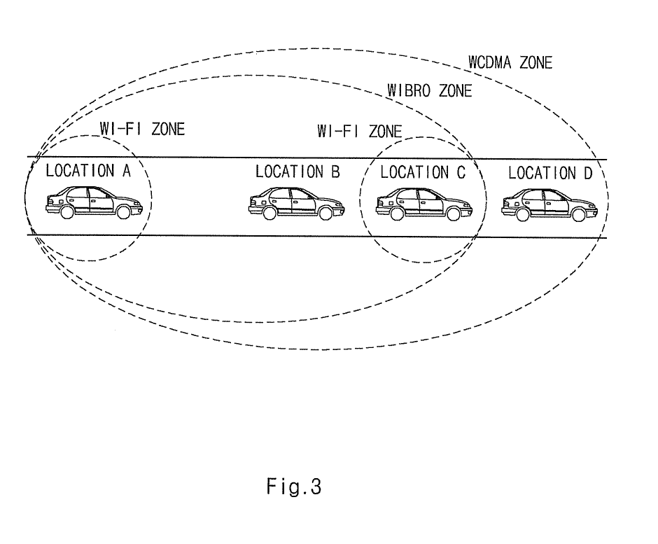

FIG. 2 is a flowchart illustrating an operation of a communication access control system of a vehicle according to an exemplary embodiment of the present invention; and FIG. 3 is a view illustrating coverage of a wireless communication module by locations of a vehicle according to an exemplary embodiment of the present invention.

Referring to FIG. 2 and FIG. 3, it is assumed that a first wireless communication module (e.g., WI-FI communication module) 10a, a second wireless communication module (e.g., WIBRO communication module) 10b, and a third wireless communication module (e.g., WCDMA communication module) 10c are provided at the communication access control system 100 of a vehicle according to the present invention. Furthermore, it is assumed that the first wireless communication module 10a, the second wireless communication module 10b, and the third wireless communication module 10c have first, second, and third access priorities of the setting unit 60, respectively. In addition, it is assumed that operation limit speeds of the first wireless communication module 10a, the second wireless communication module 10b, and the third wireless communication module 10c are set to 20 km/h, 100 km/h, and 100 km/h, respectively, by the setting unit 60.

When a vehicle engine starts and a communication access control system 100 of the vehicle operates, an access controller 50 checks a current travel speed of the vehicle (S100).

Next, the access controller 50 compares an operation limit speed of a first wireless communication module 10a with a first access priority with a current travel speed of the vehicle (S102).

When the operation limit speed of a first wireless communication module 10a is equal to or greater than a current travel speed of the vehicle, the access controller 50 operates the first wireless communication module 10a to attempt access with a contents server 200 (S104).

When the first wireless communication module 10a normally accesses the contents server 200 (when current location of the vehicle is within coverage of a base station corresponding to the first wireless communication module 10a; location A), the access controller 50 receives contents from the contents server 200 using the first wireless communication module 10a in a wireless manner (S106).

When the operation limit speed of a first wireless communication module 10a is less than the first access priority with a current travel speed of the vehicle or the first wireless communication module 10a abnormally access the contents server 200 (when the current location of the vehicle is beyond the coverage of a base station corresponding to the first wireless communication module 10a; location B), the access controller 50 compares an operation limit speed of a second wireless communication module 10b with a second access priority with the current travel speed of the vehicle (S108).

When the operation limit speed of a first wireless communication module 10a is equal to or greater than a current travel speed of the vehicle, the access controller 50 operates the second wireless communication module 10b to attempt access with the contents server 200 (S110).

When the second wireless communication module 10b normally accesses the contents server 200, the access controller 50 receives contents from the contents server 200 using the second wireless communication module 10b in a wireless manner (S112).

Next, the access controller 50 compares an operation limit speed of the first wireless communication module 10a (first priority) with an access priority higher than that of the second wireless communication module 10b at predetermined intervals in a state that the second wireless communication module 10b normally accesses the contents server 200 with current travel speed of the vehicle (S114).

When the operation limit speed of a first wireless communication module 10a is equal to or greater than the current travel speed of the vehicle, the access controller 50 operates the first wireless communication module 10a to attempt access with a contents server 200 (S116).

Next, when the first wireless communication module 10 (first priority) normally accesses the contents server 200 (location C) (S117), the access controller 50 stops the operation of the second wireless communication module 10b (second priority) (S118).

When the first wireless communication module 10a (first priority) abnormally access the contents server 200 at S114, the access controller 50 maintains an operation state of the second wireless communication module 10b (second priority) (S120).

When both of the first wireless communication module 10a with the first priority and the second wireless communication module 10b with a second priority abnormally access the contents server 200 (when the vehicle is located beyond a coverage of a base station corresponding to the first and second wireless communication modules 10a and 10b; location D) (S122), the access controller 50 compares an operation limit speed of a third wireless communication module 10c with a third priority with the current travel speed of the vehicle (S124).

Then, when the operation limit speed of a third wireless communication module 10c is equal to or greater than the third priority with the current travel speed of the vehicle, the access controller 50 operates the third wireless communication module 10c (S126).

Next, the access controller 50 receives contents from the contents server 200 using the third wireless communication module 10c in a wireless manner (S128).

As described previously, the present invention sequentially checks whether operations of the first wireless communication module 10a, the second wireless communication module 10b, and the third wireless communication module 10c are possible (operation limit speeds, access possibilities) in a priority order. Moreover, when a wireless communication module with a next order currently operates, the present invention checks whether the operation of a wireless communication module with a previous order is possible at predetermined intervals. Accordingly, the present invention can always operate a wireless communication module with a priority in a state that all wireless communication modules can operate in a current location.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A communication access control system of a vehicle comprising:
a first wireless communication module and a second wireless communication module accessing a contents server to receive contents from the contents server in a wireless manner; and
an access controller selectively operating one accessible module of the first wireless communication module or the second wireless communication module with a higher access priority in a current location of the vehicle.

2. The communication access control system of claim 1, wherein the access controller stops operation of the first wireless communication module but operates the second wireless communication module accessible in another location when an access priority of the second wireless communication module is higher than that of the first wireless communication module although the first wireless communication module operates in case where the vehicle moves to the another location.

3. The communication access control system of claim 1, further comprising a setting unit setting respective access priorities and operation limit speeds of the first wireless communication module and the second wireless communication module,
wherein the access controller operates the first wireless communication module or the second wireless communication module when the operation limit speed with respect to the first wireless communication module or the second wireless communication module is equal to or greater than a current travel speed.

4. The communication access control system of claim 1, further comprising:
a storage unit storing the contents received by the first wireless communication module or the second wireless communication module;
a repeater transmitting the contents stored in the storage unit to a terminal using a local area network; and
the terminal receiving and executing the contents from the repeater.

5. The communication access control system of claim 1, wherein the lower a communication fee is, the higher the access priority is.

6. The communication access control system of claim 3, wherein the lower a communication fee is, the higher the access priority is.
